(19) United States
(12) Patent Application Publication
(10) Pub. No.: US 2005/0278155 A1
(43) Pub. Date: Dec. 15, 2005

(54) Method of simulation of an exposure process

(76) Inventors: Chien-Ting Lai, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/887,777

(22) Filed: Jul. 9, 2004

(30) Foreign Application Priority Data
Jun. 11, 2004 (TW) 93116834

(51) Int. Cl. G06F 17/10; G06F 17/50

(52) U.S. Cl. 703/2; 703/13

(57) ABSTRACT

A method of simulation of an exposure system includes the steps of: establishing a model of an exposure system, initializing a computer, and setting relevant parameters of the exposure system in the computer; providing a pattern to be exposed, and analyzing the pattern; using a transform to transfer the pattern, and obtaining a far-field diffraction spectrum of light intensity distribution according to the pattern in a light entrance pupil plane (305) of a lens system (30) of the exposure system; multiplying the far-field diffraction spectrum by a transfer function of the exposure system to obtain an effective diffraction spectrum passing through the exposure system; and using an inverse transform according to said transform to transfer the effective diffraction spectrum, and obtaining a final light intensity distribution. The transform is a Fourier transform, a Laplace transform, a Z transform, or a T transform.

### BACKGROUND OF THE INVENTION

1. Field of the Invention

The present invention relates to computer-aided simulation methods; and especially to a method of simulation of an exposure process of photolithography employed in, for example, the manufacturing of semiconductors.

2. Description of the Prior Art

TFT-LCDs (Thin Film Transistor Liquid Crystal Displays) have been in widespread use as monitors for computers, TVs, and other displays for some time now. However, high manufacturing costs and low yield are major obstacles to successful mass production of TFT-LCDs. Generally, a method for manufacturing a semiconductor device includes a diffraction limited photolithography process. Recently, many TFT-LCD panel makers have tried to reduce the burden of the diffraction limited photolithography process. By lessening the number and complexity of diffraction limited photolithography process steps, cycle times can be reduced, and production capacity and yield can be improved. The upshot is lowered manufacturing costs.

The resolution of a diffraction limited photolithography process is mainly limited by the numerical aperture (NA) of an exposure system used in the process. The resolution is given by the Raleigh criterion shown in the following equation (1):
R=k₁λ/NA (1)
wherein R is the resolution of the diffraction limited photolithography process; k₁ is a constant determined by the exposure system and process conditions; λ is an exposure wavelength according to the exposure system; and NA is the numerical aperture of the exposure system. In particular, NA is the sine of half the angle of the image-forming cone of the light at the image. It is well known that under ideal conditions such as two incoherent point sources, the Raleigh criterion implies that the constant k₁ is 0.61. In practice, the constant k₁ depends on aberrations of the exposure system, illumination conditions (degree of coherence and intensity distribution in the aperture plane), geometrical shapes (or spatial frequency), exposure tool conditions, and photo-resists. The resolution R can be improved in three ways: by shortening the exposure wavelength according to the exposure system, by increasing the numerical aperture, or by decreasing the constant k₁.

During the diffraction limited photolithography process, a pattern to be exposed is usually adopted. The pattern may be a slit pattern, an aperture pattern, or another kind of pattern. A slit pattern is usually the preferred selection. Currently, a slit pattern mask process is in widespread use in the mass production of TFT-LCDs. Basically, the major problem in the TFT-LCD masking process is how to obtain a uniform residual photo-resist at the TFT channel area. The most important factor in obtaining such uniformity is being able to provide uniform intensity of light passing through the slits. Most studies on slit pattern design only address the slit diffraction-effect. Generally, a number of successive slit patterns must be designed until the desired slit pattern is arrived at. This increases the manufacturing costs and the cycle time of the slit pattern mask process.

In order to reduce the manufacturing costs and the cycle time of the slit pattern mask process, a method of simulation of the slit pattern mask process using computers has been developed. FIG. 12 shows a representation of the simulation method. Reference numeral 101 denotes a transmission region of a mask pattern 11. Reference numeral 102 denotes a region of a photo-resist layer 12 arranged on a substrate 13 corresponding to the transmission region 101. Reference numeral 103 denotes a non-transmission region of the mask pattern 11. Reference numeral 104 denotes a region of the photo-resist layer 12 corresponding to the non-transmission region 103. Reference numeral 105 denotes an exposed portion of the mask pattern 11. Reference numeral 106 denotes a region of the photo-resist layer 12 corresponding to the exposed portion 105.

The distribution pattern of the exposed portion 105 is simulated to be that of a grating, and then light beams 10 are diffracted by many slits of the exposed portion 105 as they pass therethrough. Reference numeral 14 denotes the diffraction region. Reference numeral 15 denotes the irradiance distribution for the diffraction on the photo-resist layer 12. Because the region 106 corresponds to the exposed portion 105, the photo-resist of the region 106 is thinner than that of the region 104.

The above-described simulation method only simulates the diffraction effect, whereas the actual exposure process requires the use of several optical elements. Therefore the exposure obtained by the simulation method does not accord with the actual exposure, and the accuracy of the simulation method is relatively poor.

### SUMMARY OF THE INVENTION

An object of the present invention is to provide a highly accurate method of simulation of an exposure process.

In order to achieve the object set out above, a method of simulation of an exposure process includes the steps of: establishing a model of an exposure system, initializing a computer, and setting relevant parameters of the exposure system in the computer; providing a pattern to be exposed, and analyzing the pattern; using a transform to transfer the pattern, and obtaining a far-field diffraction spectrum of light intensity distribution according to the pattern in a light entrance pupil plane of a lens system of the exposure system; multiplying the far-field diffraction spectrum by a transfer function of the exposure system to obtain an effective diffraction spectrum passing through the exposure system; and using an inverse transform according to said transform to transfer the effective diffraction spectrum, and obtaining a final light intensity distribution. The transform is a Fourier transform, a Laplace transform, a Z transform, or a T transform.

The result of carrying out the simulation method is substantially the same as the result of actual exposure. In other words, the simulation result of the exposure system using the simulation method is accurate. Because the simulation method is implemented with the computer, relevant parameters can be conveniently changed in order to arrive at the desired pattern. The simulation method can reduce the cycle time of design of the pattern.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic view of an exposure system used in an exposure process according to the present invention, the exposure system comprising a lens system, a light entrance pupil plane of the lens system, and a light exit pupil plane of the lens system.

FIG. 2 is a flow chart of a method of simulation of an exposure process in accordance with the present invention.

FIG. 3 is a schematic view of slit patterns according to the simulation method of the present invention.

FIG. 4 is a far-field diffraction spectrum of light intensity distribution according to the slit pattern of FIG. 3 in the light entrance pupil plane of FIG. 1, as obtained by the simulation method of the present invention.

FIG. 5 is an optical transfer function of the exposure system of FIG. 1 in a frequency field, showing a diffraction light intensity distribution in the light entrance pupil plane of FIG. 1.

FIG. 6 is an effective diffraction spectrum of light intensity distribution in the light exit pupil plane of FIG. 1, as obtained by the simulation method of the present invention.

FIG. 7 is a graph of a final light intensity distribution in accordance with the simulation method of the present invention, when a width of each slit in FIG. 3 is 1.2 μm.

FIG. 8 is an effective diffraction spectrum of the final light intensity distribution shown in FIG. 7.

FIG. 9 is a stereoscopic view of an actual exposure pattern obtained using a slit pattern having a slit width of 1.2 μm.

FIG. 10 is a planform view of the actual exposure pattern shown in FIG. 9.

FIG. 11 is a cross-sectional view corresponding to line XI-XI of FIG. 9.

FIG. 12 is a schematic representation of a conventional method of simulation used in a slit pattern mask process.

### DETAILED DESCRIPTION OF THE INVENTION

The present invention provides a method of simulation of an exposure process used in a diffraction limited photolithography process. FIG. 1 is a schematic view of an exposure system to be simulated. The exposure system includes a lens system 30 functioning as an exposure tool, an object plane 303, an image plane 304, and a light source 301 arranged in the object plane 303. The lens system 30 includes a light entrance pupil plane 305 and a light exit pupil plane 306. Light beams from the light source 301 enter the lens system 30 by passing through the light entrance pupil plane 305, and then exit from the light exit pupil plane 306 to form an image 302 on the image plane 304. Reference Z₀ denotes the object distance, which is the distance from the object plane 303 to the light entrance pupil plane 305. Reference Z₁ denotes the image distance, which is the distance from the image plane 304 to the light exit pupil plane 306.

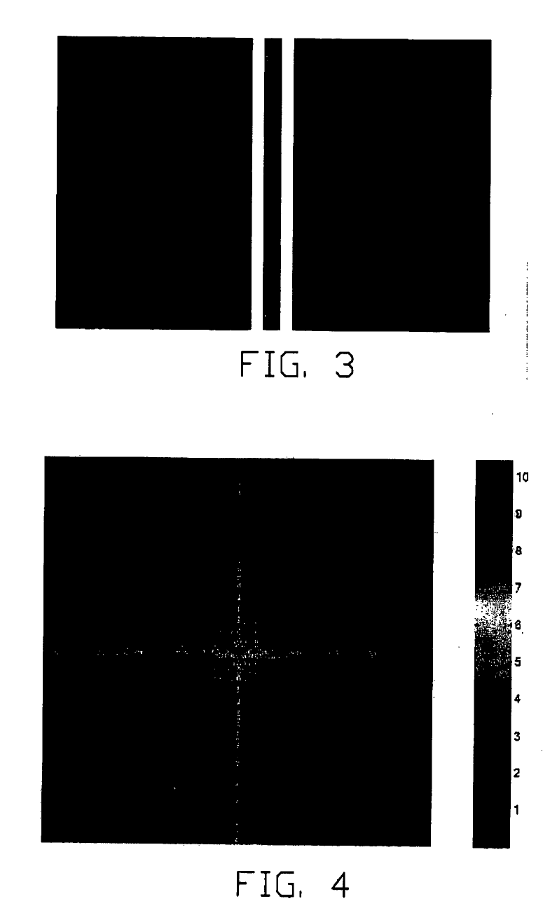

In the preferred embodiment of the present invention, the pattern to be exposed in the diffraction limited photolithography process is a slit pattern, as shown in FIG. 3. The light entrance and exit pupil planes 305, 306 are in fact images of the same slit pattern within the exposure system, which is the true physical source of the resolution-limited exposure system. In the exposure system, the Fresnel number is given by the following equation (2):
NF≡a²/(λ·z) (2)
In equation (2), a is the characteristic size of a slit pattern to be exposed; λ is a wavelength of light from the light source 301; and z is the distance from the light source 301 to the light entrance pupil plane 305. In the exposure system, the Fresnel number N_{F}<<1 belongs to the far-field diffraction region.

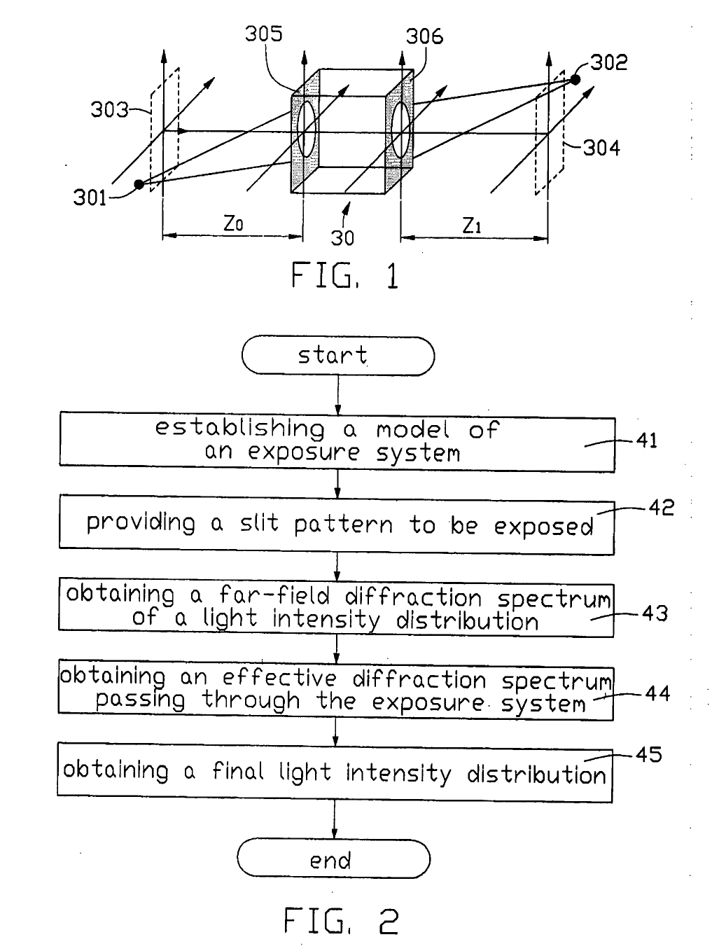

FIG. 2 is a flow chart of the method of simulation of an exposure process according to the slit pattern using the exposure system. The simulation method includes the steps of establishing a model of an exposure system (Step 41), providing a slit pattern to be exposed (Step 42), obtaining a far-field diffraction spectrum of a light intensity distribution (Step 43), obtaining an effective diffraction spectrum passing through the exposure system (Step 44), and obtaining a final light intensity distribution (Step 45).

Referring to FIGS. 3 to 6, details of the above-described steps 41-45 are as follows:

Step 41: Establishing a model of the exposure system, initializing a computer, and setting the relevant parameters of the exposure system in the computer.

Step 42: Providing a slit pattern to be exposed, as shown in FIG. 3, and analyzing the slit pattern. Analyzing the slit pattern includes storing the slit pattern in a memory, and digitizing the slit pattern using an image disposal device, wherein a diffraction limited system is composed of the exposure system and the slit pattern arranged in the object plane 303 of the exposure system.

Step 43: Referring to FIG. 4, using a Fourier transform to transfer the slit pattern, and obtaining a far-field diffraction spectrum of light intensity distribution according to the slit pattern in the light entrance pupil plane 305 of the lens system 30.

Step 44: Multiplying the far-field diffraction spectrum by the optical transfer function of the lens system 30, and obtaining the effective diffraction spectrum that will pass through the lens system 30, wherein the cutoff frequency f₀ of the diffraction limited system is given by the following equation (3):
f₀=NA/λ (3)
For example, in the Canon Company's MPA-series exposure system, NA=0.085, and a mercury (Hg) lamp light wavelength is 436 nm (g-line) or 405 nm (h-line) or 365 nm (i-line). Under these conditions, the f₀ is 0.195 or 0.210 or 0.233 according to the relevant wavelength. This means that a reduced wavelength represents a larger effective pupil, which functions as a low-pass filter. In fact, the light source of the exposure system is incoherent light, and the cutoff frequency f₀ᵢ=2*f₀. In the case of incoherent light, the image light intensity is given by the following convolution equation (4):
Iᵢ(x,y)=I_{g}(x,y) [symbol] h_{I}(x,y) (4)
In the convolution equation (4), Iᵢ(x,y) is the light intensity distribution function of the light entrance pupil plane 305 of the lens system 30; I_{g}(x,y) is the light intensity distribution function of the light exit pupil plane 306 of the lens system 30; and h_{I}(x,y) is the optical transfer function of the exposure system in the space domain.

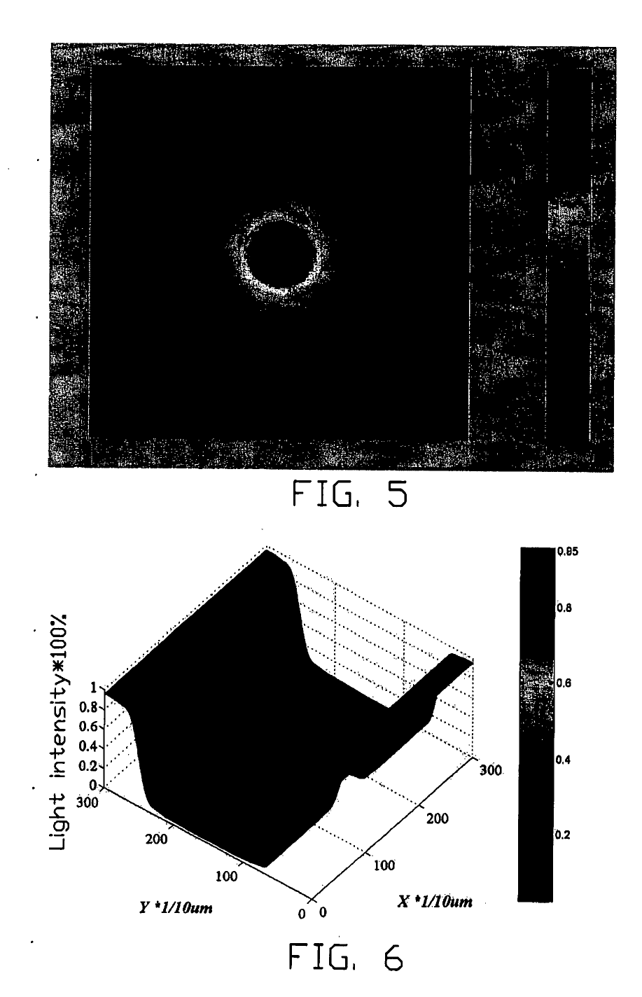

Based on the convolution theorem, the convolution equation (4) is made entirely equivalent to the following simpler equation (5):
ℑ{Iᵢ(x,y)}={I_{g}(x,y)}ℑ{h_{I}(x,y)}=G_{iI}(μ,v)H_{I}(p,v) (5)
H_{I}(μ,v) is the optical transfer function of the exposure system in the frequency domain shown in FIG. 6. G_{iI}(μ,v) is the far-field diffraction spectrum of the light intensity distribution. Using equation (5), the effective diffraction spectrum passing through the light exit pupil plane 306 of the lens system 30 can be obtained.

Step 45: Using an inverse Fourier transform to transfer the effective diffraction spectrum, and obtaining the following equation (6):
Iᵢ(x,y)=ℑ−¹{G_{iI}(μ,v)·H_{I}(p,v)} (6)
Equation (6) is the final light intensity distribution. By transforming equation (6) into an image, the final simulation result can be obtained.

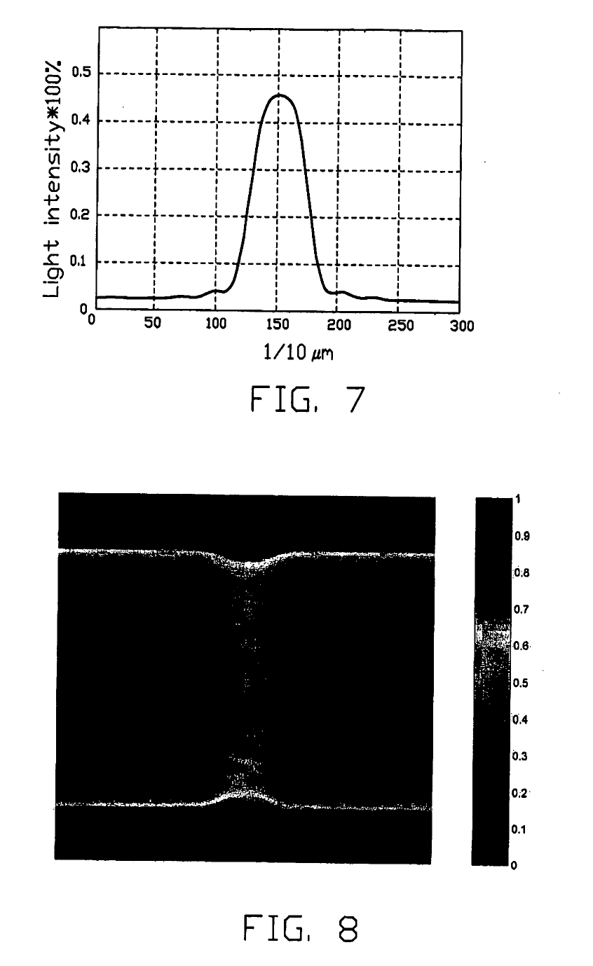

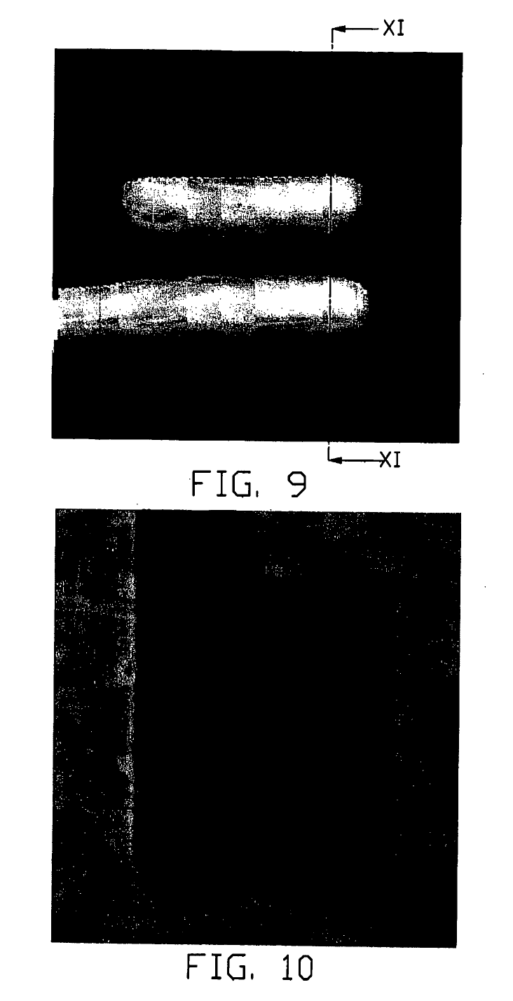

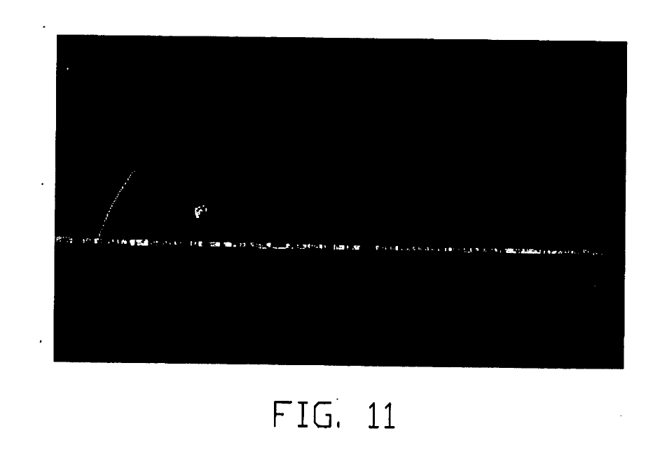

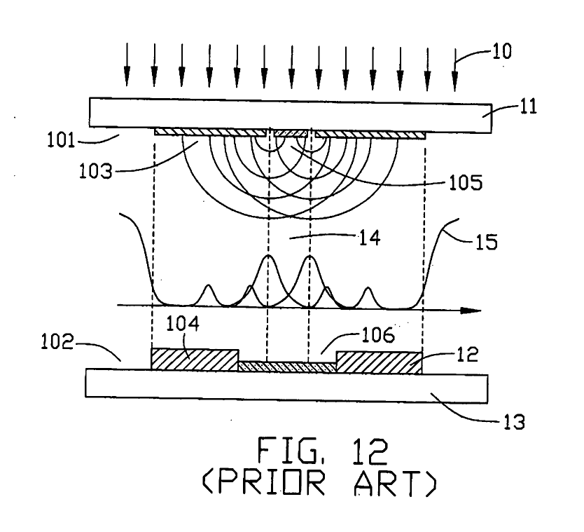

When the slit width of the slit pattern is 1.2 μm, the simulation result using the simulation method is that illustrated in FIGS. 7 and 8. FIG. 7 is a graph of the final light intensity distribution. FIG. 8 is an effective diffraction spectrum of the final light intensity distribution shown in FIG. 7. The result of actual exposure of the slit pattern is illustrated in FIGS. 9, 10 and 11. FIG. 9 is a stereoscopic view of the actual exposure pattern obtained. FIG. 10 is a planform view of the actual exposure pattern obtained. FIG. 11 is a cross-sectional representation of the actual exposure pattern obtained, corresponding to line XI-XI of FIG. 9.

As indicated above, the simulation result is substantially the same as the actual exposure result. In other words, the simulation result of the exposure system using the simulation method is accurate. Because the simulation method is implemented with the computer, relevant parameters can be conveniently changed in order to arrive at the desired slit pattern. Thus the simulation method can reduce the cycle time of design of the slit pattern.

Various kinds of photolithography processes employed in the manufacturing of semiconductors can be simulated using the simulation method. The simulation method also can be applied to simulate processes employed in the manufacturing of liquid crystal displays, especially to the design of optical bumps of reflective type liquid crystal displays (RLCDs) and transflective type liquid crystal displays (TRLCDs).

In addition, the above-described method of obtaining the light intensity distribution of far-field diffraction in the light entrance pupil plane 30 of the exposure system is not limited to a Fourier transform. Other means such as a Laplace transform, a Z transform, or a T transform can also be employed. Furthermore, the pattern to be exposed may be an aperture pattern instead of a slit pattern.

It is to be further understood that, even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of simulation of an exposure process, comprising the steps of:
establishing a model of an exposure system, initializing a computer, and setting relevant parameters of the exposure system in the computer;
providing a pattern to be exposed, and analyzing the pattern;
using a transform to transfer the pattern, and obtaining a far-field diffraction spectrum of light intensity distribution according to the pattern in a light entrance pupil plane of a lens system of the exposure system;
multiplying the far-field diffraction spectrum by a transfer function of the exposure system to obtain an effective diffraction spectrum passing through the exposure system; and
using an inverse transform according to said transform to transfer the effective diffraction spectrum, and obtaining a final light intensity distribution.

2. The simulation method of claim 1, wherein said transform is a Fourier transform.

3. The simulation method of claim 1, wherein said transform is a Laplace transform.

4. The simulation method of claim 1, wherein said transform is a T transform.

5. The simulation method of claim 1, wherein said transform is a Z transform.

6. The simulation method of claim 1, wherein analyzing the pattern comprises storing the pattern in a memory of the computer.

7. The simulation method of claim 1, wherein analyzing the pattern comprises digitizing the pattern using an image disposal device.

8. The simulation method of claim 1, wherein the pattern is a slit pattern.

9. The simulation method of claim 1, wherein the pattern is an aperture pattern.

10. A method of simulation of an exposure process, comprising the steps of:
establishing a model of an exposure system, initializing a computer, and setting relevant parameters of the exposure system in the computer;
providing a pattern to be exposed, and analyzing the pattern;
using a transform to transfer the pattern, and obtaining a far-field diffraction spectrum of light intensity distribution according to the pattern in a light entrance pupil plane of a lens system of the exposure system;
transferring the far-field diffraction spectrum by a transfer function of the exposure system to obtain an effective diffraction spectrum passing through the exposure system; and
using another transform according to said transform to transfer the effective diffraction spectrum, and obtaining a final light intensity distribution.
